(19) United States
(12) Patent Application Publication
(10) Pub. No.: US 2009/0256664 A1
(43) Pub. Date: Oct. 15, 2009

(54) Solenoid switch and cover

(76) Inventors: Mahesh Jaywant Rane, Secunderabad (IN); Janakiraman Narayanan, Andra Pradesh (IN); Sachin Kurkure, Andra Pradesh (IN); Simhadri Ramalingeswara Gupta, Andra Pradesh (IN)

Correspondence Address: General Electric Company;GE Global Patent Operation, PO Box 861, 2 Corporate Drive, Suite 648, Shelton, CT, 06484, US

(21) Appl. No.: 12/103,015

(22) Filed: Apr. 15, 2008

(51) Int. Cl. H01F 7/08

(52) U.S. Cl. 335/258; 335/255

(57) ABSTRACT

A solenoid includes a support and an electrical winding located at the support. A plunger may be provided that is movable in response to energization of the electrical winding and an actuator may also be provided that is adjustable relative to the plunger and interconnected therewith. The solenoid may further include at least one switch responsive to movement of the plunger. A solenoid cover is also presented.

### BACKGROUND OF THE INVENTION

1. Field of the Invention

The subject matter described herein relates generally to electrical devices and methods for switching and, more particularly, to solenoids.

2. Related Art

In general, solenoids are well known. For example, U.S. Pat. No. 6,724,286 describes an adjustable solenoid for a circuit breaker that comprises a support, a plunger, a mechanical biasing mechanism and a winding. A stator may be provided that has a first threaded portion engaged within a threaded opening of the enclosure that causes the stator to travel between a first position and a second position as a rotational force is applied to the stator. The first position is closer to the plunger than the second position and the stator has a second threaded portion for engaging a threaded portion of the support. The second threaded portion of the stator causes the support to travel between a first position and a second position, the second position of the support provides the mechanical biasing mechanism with a greater biasing force than the first position.

The adjustable solenoid, while suitable for intended purposes, suffers from the drawback that it has a relatively large footprint/volume. It is now desired to provide a reduced footprint/volume of the solenoid.

### BRIEF DESCRIPTION OF THE INVENTION

In accordance with an embodiment of the present invention, a solenoid comprises a support and an electrical winding located at the support. A plunger may be provided that is movable in response to energization of the electrical winding and an actuator may also be provided that is adjustable relative to the plunger and interconnected therewith. The solenoid may further comprise at least one switch responsive to movement of the plunger.

In another aspect of the invention a solenoid comprises a support, an electrical winding located at the support and a core that, in turn, comprises a tapered portion. A plunger may be provided that comprises a correspondingly tapered portion for mating with the core and that is movable in response to energization of the electrical winding. At least one switch is provided that is responsive to movement of the plunger.

In a further aspect of the invention a solenoid cover for fitting to a housing of a circuit breaker is presented. The circuit breaker may comprise a support, an electrical winding located at the support, a plunger movable in response to energization of the electrical winding, and an actuator adjustable relative to the plunger and interconnected therewith. The solenoid cover comprises a working surface, a switch mounting plate located at the working surface and at least one switch supported by the mounting plate.

### BRIEF DESCRIPTION OF THE DRAWINGS

The following detailed description is made with reference to the accompanying drawings, in which:

FIG. 1 is a perspective view of a solenoid assembly comprising an under voltage (UV) release in accordance with one embodiment of the present invention;

FIG. 2 is a diagrammatical, sectional view of the UV release of FIG. 1 comprising a solenoid including a plunger in an extended position;

FIG. 3 is another diagrammatical, sectional view showing the UV release of FIG. 1 with the plunger in a retracted position;

FIG. 4 is a diagrammatical, sectional view showing a shunt release comprising a solenoid in accordance with another embodiment of the present invention and the shunt release comprising a plunger shown in an extended position;

FIG. 5 is another diagrammatical, sectional view showing the shunt release of FIG. 4 with the plunger in a retracted position;

FIG. 6 is flux diagram showing a flux circuit and flux concentrations in the solenoid of FIG. 2;

FIG. 7 is an exploded view of the solenoid assembly of FIG. 1 including a status indication module; and

FIG. 8 is a perspective view of the status indication module of FIG. 7.

### DETAILED DESCRIPTION OF THE PREFERRED EMBODIMENT

One embodiment of the present invention concerns a solenoid that has a reduced footprint while having an increased flux density and being capable of signaling an energized status of the solenoid. In one particular embodiment, the solenoid comprises a support, an electrical winding located at the support, a plunger movable in response to energization of the electrical winding, an actuator adjustable relative to the plunger and interconnected therewith and at least one switch closable in response to movement of the plunger.

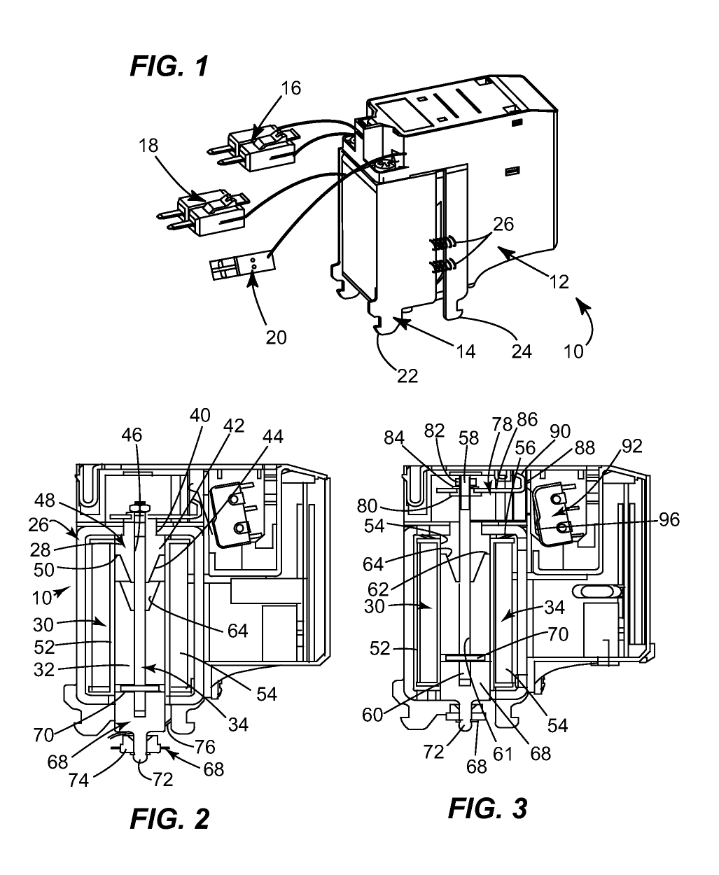

Referring now to FIG. 1, a solenoid assembly in accordance with one embodiment of the present invention is illustrated generally at 10. In this embodiment, the solenoid assembly 10 is configured as an under voltage release (UVR) and comprises a housing 12, mounting clasp 14, an accessory plug 16, a status indication connector 18 and another status indication connector 20.

The housing 12 may comprise an insulating polymeric material such as a plastic material and is interconnected with the mounting clasp 14 that supports the housing in an appropriately configured power distribution panel (not shown). The mounting clasp 14 comprises hooked portions 22 and 24 that are separated by springs 26 in a known manner.

The accessory plug 16 and the status indication connectors 18 and 20 are connected to a switch (described in more detail below) that is actuated upon energization of a solenoid (also described in more detail below). The accessory plug 16 may be configured for connection to a power source through secondary disconnect (SD) (not shown). The status indication connector 18 may be configured for connection to the SD and the status indication connector 20 may be configured for connection to an electronic protection device of the circuit breaker.

Referring now to FIGS. 2 and 3, the solenoid assembly 10 may further comprise a support 26 disposed within the housing 12, a core 28, a coil assembly 30, an actuator 32 and a plunger 34. The support 26 may be a onepiece component comprising a ferromagnetic material such as an iron or steel.

The core 28 comprises a ferromagnetic material such as iron, a mounting portion 40, a base portion 42 and a tapered portion 44. Each of the mounting portion 40, the base portion 42 and the tapered portion 44 may be disposed about a central bore 46. The mounting portion 40 may be fixed to support 26 via e.g. riveting. The base portion 42 may comprise an increased diameter relative to the mounting portion 40 and comprises opposing shoulders 48 and 50. The tapered portion 44, in an exemplary embodiment, may generally comprise a decreasing outer diameter in a direction away from the mounting portion. For example, in one particular embodiment, the tapered portion may be generally conical in outer configuration, although, other embodiments such as a generally stepped outer configuration are contemplated by the present invention. This tapered configuration contributes to enhanced flux concentration as described in more detail below.

The coil assembly 30 comprises a bobbin 52 and a winding 54. The bobbin 52 comprises a moldable material such as a plastic and a bore 54 that is dimensioned to receive the base portion 42 of the core 28. The bobbin 52 may be disposed adjacent a spacer such as a wavy washer 56 which provides a resilient fit for the bobbin between the support brackets 36 and 38. The winding 54 may comprise one or more insulated wires wound about the bobbin 52 in a known manner. In this embodiment the winding 54 may be connected to a circuit (not shown) that is to be monitored for an under voltage.

The actuator 32 may be rod-like in outer configuration and may comprise a ferromagnetic material such as iron or steel. The actuator 32 may comprise opposing threaded end portions 58 and 60.

The plunger 34 may comprise a ferromagnetic material such as iron or steel and is dimensioned to slidably fit within the bore 54 of the bobbin 52. The plunger comprises a central bore 61 and a tapered terminal end portion 62 that is configured to correspond with the tapered portion 44 of the core 28. In an exemplary embodiment, the tapered terminal end portion 62 may generally comprise an inset portion 64 that has an increasing inner diameter in a direction towards the terminal end portion 62. For example, in one particular embodiment, the inset portion 64 may be generally inversely conical in configuration, although, other embodiments such as a generally stepped inner configuration are contemplated by the present invention.

Referring now to FIG. 6, it can be seen that because of the increased surface area provided by each corresponding tapered portion 44 and inset portion 64, the resulting flux lines 66 are shown concentrated together therebetween. This increased concentration or density of the flux between the tapered portion 44 and inset portion 64 creates an enhanced attraction force therebetween which, in turn, provides for a reduced size or diameter of the plunger 34 and the core 28 and, in turn, a reduced dimension of the solenoid assembly 10.

Referring again to FIG. 3, the actuator 32 may be connected with the plunger 34 by means of a dowel pin 70. The plunger 34 comprises a protrusion 72 upon which may be mounted a connector 74 by means of a circlip 68. The connector 74 functions to retain a compression spring 76 in position.

In accordance with another embodiment of the present invention, a switch actuator 78 may be interconnected with the actuator 32. In this embodiment, the switch actuator 78 comprises a generally stiff but resilient material such as a sheet metal and is clamped adjacent a stop 80 via a nut 82 and washer 84. The switch actuator 78 comprises a mounting portion 86 and a wiper portion 88. The wiper portion may terminate in a curled flange 90.

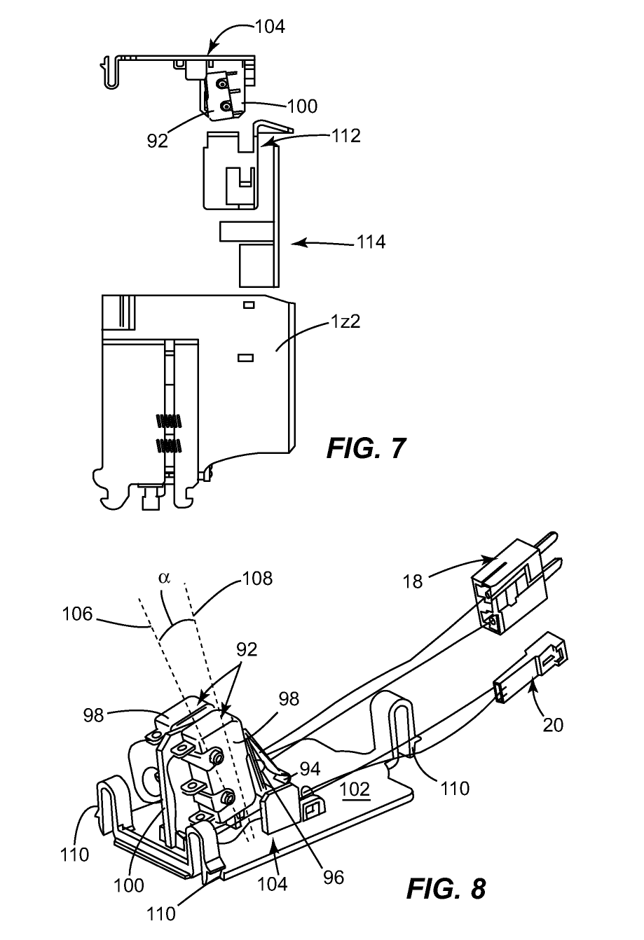

Referring now also to FIGS. 7 and 8, the solenoid assembly 10 may further comprise a signaling switch 92 that, in turn, comprises a switch lever 94 and a toggle 96. The switch lever 94 comprises a relatively stiff but flexible material such as a sheet metal and may extend from a housing 98 of the signaling switch in the form of a cantilever. The switch lever 94 extends over the toggle 96 and, upon urging by the switch actuator 78, will move the toggle into the housing 98.

As best seen in FIGS. 7 and 8 and in one particular embodiment of the present invention, a pair of signaling switches 92 may be mounted to a mounting plate such as a fin 100 that extends from a working surface 102 of a cover 104. The signaling switches 92 may be mounted such that a longitudinal axis 106 of the signaling switches 92 at an acute angle (a) with respect to an orthogonal projection 108 from the working surface 102. The cover 104 also comprises resilient arms 110 that are used to mount the cover to the housing 12.

Turning now solely to FIG. 7, the cover 104 may be disposed within an insulating sleeve 112 for isolation from an electronics package 114.

In operation, when the coil winding 54 is sufficiently energized, such that it is not an under voltage condition, the plunger 34 and actuator 32 are moved from an extended position as shown in FIG. 2 to a retracted position in FIG. 3. In the retracted position, the tapered portion 44 and the inset portion 64 are engaged and the switch actuator 78 moves the switch lever 94 to toggle the switch 92 to an “on” position. This change may then be observed via connection with the status indication connectors 18 and 20. Upon cessation of energy to the coil winding 54, the compression spring 76 will return the plunger to the extended position as shown in FIG. 2.

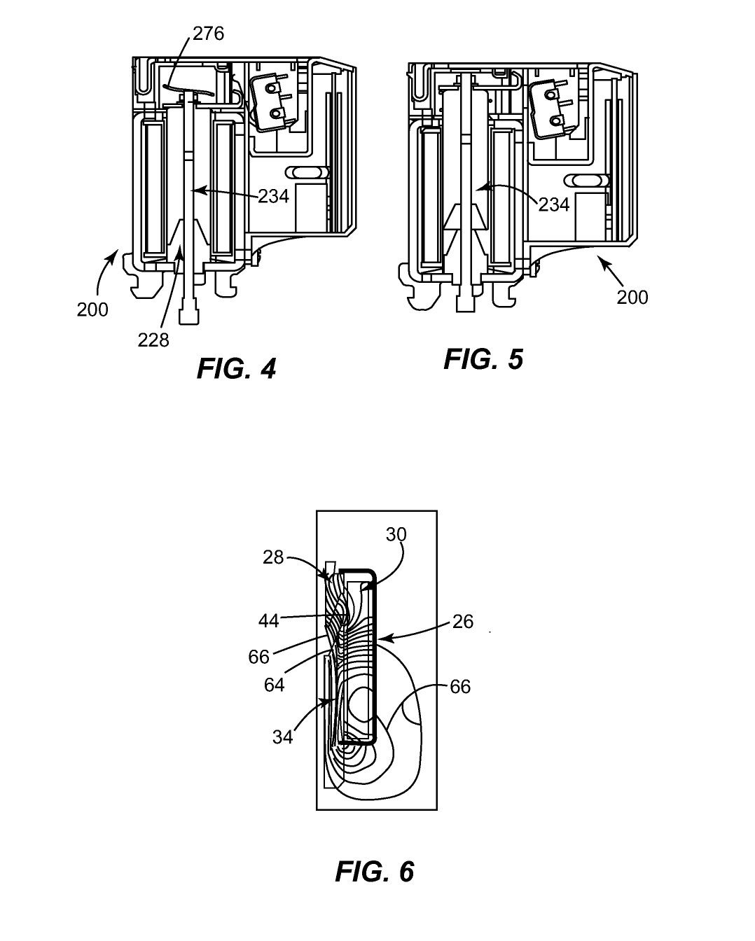

Referring now to FIGS. 2, 4 and 5, another embodiment of a coil assembly is shown generally at 200. The coil assembly 200 may be similar to the coil assembly 10, although, it is configured in the form of a shunt release and thus some differences from that of the coil assembly 10 are shown and described hereafter. As shown, the coil assembly 200 comprises a plunger 234 and core 2228 that are reverse mounted with respect to the coil assembly 34 and omits the end tip 68, washer 70 and connector 74. Also, a compression spring 276 is disposed at an opposite terminal end of the plunger 234 from the plunger 34.

While the present invention has been described in connection with what are presently considered to be the most practical and preferred embodiments, it is to be understood that the present invention is not limited to these herein disclosed embodiments. Rather, the present invention is intended to cover all of the various modifications and equivalent arrangements included within the spirit and scope of the appended claims.

What is claimed is:

1. A solenoid, comprising:
a support;
an electrical winding located at the support;
a plunger movable in response to energization of the electrical winding;
an actuator adjustable relative to the plunger and interconnected therewith; and
at least one switch responsive to movement of the plunger.

2. The solenoid of claim 1, further comprising a switch actuator movable with the plunger and wherein the at least one switch comprises a switch lever engageable by the switch actuator.

3. The solenoid of claim 2, wherein the switch actuator comprises a mounting portion having a generally flat shape and a wiper portion extending in a generally orthogonal direction to the mounting portion, the wiper portion terminating in a curled flange portion.

4. The solenoid of claim 2, wherein the switch lever comprises a resilient member configured to be urged into engagement with a toggle in response to movement of the switch actuator, the switch lever terminating in a curved end tip.

5. The solenoid of claim 1, wherein the plunger comprises a terminal end portion and wherein the solenoid further comprises a core interconnected with the support and fixed with respect thereto and the core having a bore wherethrough the actuator is slidably disposed and a tapered portion being configured to mate with a correspondingly tapered portion of the terminal end portion of the plunger.

6. The solenoid of claim 5, wherein:
the tapered portion of the core comprises a conical shape;
the correspondingly tapered portion of the terminal end portion of the plunger comprises an inverted conical shape; and
each of the conical shape and the inverted conical shape are correspondingly configured for mating together.

7. The solenoid of claim 1, wherein the actuator comprises a threaded end portion and the plunger comprises a correspondingly threaded bore.

8. The solenoid of claim 1, wherein the plunger is biased.

9. The solenoid of claim 1, further comprising:
a housing wherein the support is located; and
a cover configured to fit to the housing and whereupon the at least one switch is mounted.

10. The solenoid of claim 9, wherein the at least one switch comprises a microswitch that is mounted to the cover at an acute angle to a longitudinal axis defined by a working surface of the cover.

11. The solenoid of claim 9, wherein the cover comprises a plurality of generally U-shaped resilient arms for snap locking the cover to the housing.

12. The solenoid of claim 10, wherein the at least one switch comprises a plurality of switches each electrically connected to a terminal connector mounted to the housing.

13. A solenoid, comprising:
a support;
an electrical winding located at the support;
a core comprising a tapered portion;
a plunger comprising a correspondingly tapered portion for mating with the core and being movable in response to energization of the electrical winding; and
at least one switch responsive to movement of the plunger.

14. The solenoid of claim 13, wherein:
the tapered portion of the core comprises a conical shape;
the correspondingly tapered portion of the terminal end portion of the plunger comprises an inverted conical shape; and
each of the conical shape and the inverted conical shape are correspondingly configured for mating together.

15. The solenoid of claim 13, further comprising:
at least one switch responsive to movement of the plunger.
a switch actuator movable with the plunger and wherein the at least one switch comprises a switch lever engageable by the switch actuator.

16. The solenoid of claim 15, wherein the switch actuator comprises a mounting portion having a generally flat shape and a wiper portion extending in a generally orthogonal direction to the mounting portion, the wiper portion terminating in a curled flange portion.

17. The solenoid of claim 15, wherein the switch lever comprises a resilient member configured to be urged into engagement with a toggle in response to movement of the switch actuator, the switch lever terminating in a curved end tip.

18. A solenoid cover for fitting to a housing of a circuit breaker, the circuit breaker comprising a support, an electrical winding located at the support, a plunger movable in response to energization of the electrical winding, and an actuator adjustable relative to the plunger and interconnected therewith and the solenoid cover, comprising:
a working surface;
a switch mounting plate located at the working surface; and
at least one switch supported by the mounting plate.

19. The solenoid cover of claim 18, wherein the at least one switch comprises a microswitch that is mounted to the cover at an acute angle to a longitudinal axis defined by the working surface of the cover.

20. The solenoid cover of claim 18, wherein the cover comprises a plurality of generally U-shaped resilient arms for snap locking the cover to the housing.

21. The solenoid cover of claim 18, wherein the at least one switch comprises a plurality of switches each electrically connected to a terminal connector mounted to the housing.
